(19) United States
(12) Patent Application Publication
(10) Pub. No.: US 2025/0208270 A1
(43) Pub. Date: Jun. 26, 2025

(54) LIDAR SENSOR CAPABLE OF ADJUSTING EXPOSURE TIME

(71) Applicants: SolidVue Inc., Seongnam-si Gyeonggi-do (KR); UNIST (ULSAN NATIONAL INSTITUTE OF SCIENCE AND TECHNOLOGY), Ulju-gun Ulsan (KR)

(72) Inventors: Seonghyeok PARK, Ulju-gun Ulsan (KR); Seong-Jin KIM, Anyang-si Gyeonggi-do (KR); Canxing PIAO, Suwon-si Gyeonggi-do (KR)

(73) Assignees: SolidVue Inc., Seongnam-si Gyeonggi-do (KR); UNIST (ULSAN NATIONAL INSTITUTE OF SCIENCE AND TECHNOLOGY), Ulju-gun Ulsan (KR)

(21) Appl. No.: 18/939,098

(22) Filed: Nov. 6, 2024

(30) Foreign Application Priority Data
Dec. 22, 2023 (KR) 10-2023-0189946

(51) Int. Cl. G01S 7/487; G01S 7/4863; G01S 7/4865; G01S 17/14

(52) U.S. Cl. CPC G01S 7/4873; G01S 7/4863; G01S 7/4865; G01S 17/14

(57) ABSTRACT

A light detecting and ranging (LiDAR) sensor includes a light detection circuit generating a light detection signal by detecting light; a flight time detection circuit performing a threshold determination mode for determining a threshold during a reference time, and performing a coarse mode for comparing an accumulated value of the light detection signal after light is irradiated from a light source with the threshold to determine a flight time corresponding to a distance to an object with a first resolution; and a pixel control circuit controlling the flight time detection circuit for performing the threshold determination mode and the coarse mode, wherein the flight time detection circuit determines the threshold by performing a logical operation on a count value which is an accumulation of light the detection signal during the reference time when the light is not irradiated while the threshold determination mode is performed.

### CROSS-REFERENCE TO RELATED APPLICATION

The present application claims priority under 35 U.S.C. § 119(a) to Korean Patent Application No. 10-2023-0189946, filed in the Korean Intellectual Property Office on Dec. 22, 2023, which application is incorporated herein by reference in its entirety.

### BACKGROUND

### 1. Technical Field

Embodiments generally relate to a light detection and ranging (LiDAR) sensor that can adjust exposure time.

### 2. Related Art

A LiDAR sensor is a device that measures distance to an object by analyzing reflected light after irradiating laser and is used in various fields such as an autonomous vehicle and a mobile device for augmented reality.

A conventional LiDAR sensor includes a number of pixel circuits arranged in a grid pattern, and each pixel circuit measures time of flight (ToF) corresponding to time between when the laser is irradiated and when reflected light is received.

A LiDAR sensor uses a single photon avalanche diode (SPAD) that can be manufactured using CMOS process technology as a light-receiving element, but noise pulses generated due to the characteristics of the element itself and ambient light deteriorate signal-to-noise ratio (SNR) characteristics.

The SNR characteristics may be improved by collecting a large amount of data. To this end, the time-correlated single photon counting (TCSPC) method is used, which stores histogram data within the pixel and statistically extracts ToF information that is correlated with time.

The laser is irradiated a predetermined number of times at a regular period and then reflected light is detected to generate the histogram.

The conventional LiDAR sensor has deterioration in SNR characteristics and has a limited measurement range when the ambient light becomes stronger, so the exposure time must be increased to overcome this.

In the case of a LiDAR sensor used in various environments such as autonomous driving vehicle, the exposure time must be fixed by fixing the number of laser irradiations based on the darkest object at the farthest distance, and the histogram information must be stored in the memory using reflected light information measured at each pixel circuit during the exposure time.

Accordingly, a conventional LiDAR sensor has a problem in that waiting time for the predetermined exposure time increases even after receiving reflected light corresponding to the laser irradiation at the pixel circuit, and the histogram information accumulated in the memory increases unnecessarily, requiring a large memory.

### SUMMARY

In accordance with an embodiment of the present disclosure, a light detection and ranging (LiDAR) sensor may include a light detection circuit configured to generate a light detection signal by detecting light; a flight time detection circuit configured to perform a threshold determination mode for determining a threshold during a reference time, and to perform a coarse mode for comparing an accumulated value of the light detection signal after light is irradiated from a light source with the threshold to determine a flight time corresponding to a distance to an object with a first resolution; and a pixel control circuit configured to control the flight time detection circuit for performing the threshold determination mode and the coarse mode, wherein the flight time detection circuit determines the threshold by performing a logical operation on a count value which is an accumulation of the light detection signal during the reference time when the light is not irradiated while the threshold determination mode is performed.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates an operation of a LiDAR sensor according to an embodiment of the present disclosure.

FIG. 2 illustrates a pixel circuit according to an embodiment of the present disclosure.

FIG. 3 is a graph showing thresholds according to an embodiment of the present disclosure.

FIG. 4 is a state diagram illustrating operations of a LiDAR sensor according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

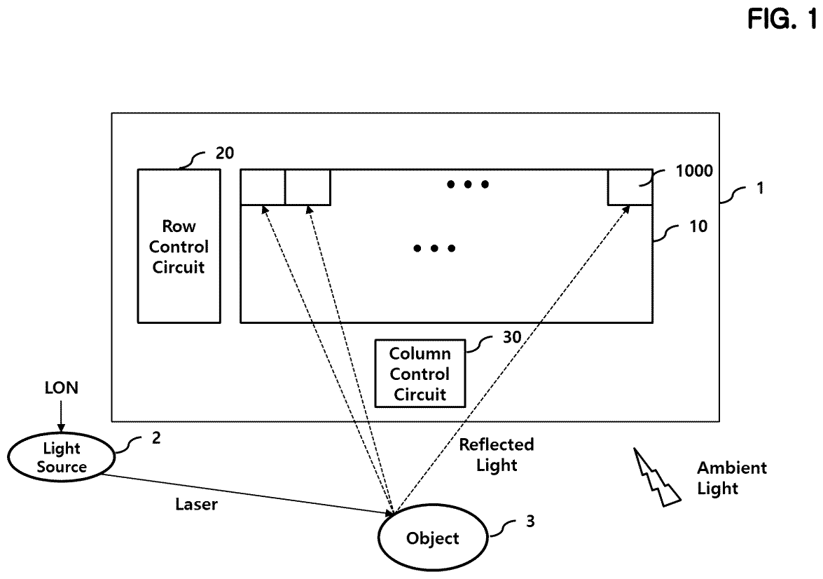

FIG. 1 is a diagram showing an operation of a light detection and ranging (LiDAR) sensor 1 according to one embodiment of the present disclosure.

The LiDAR sensor 1 includes a pixel array 10 including a plurality of pixels 1000 arranged in a grid pattern, a row control circuit 20 that controls the pixel array 10 in rows, and a column control circuit 30 that controls the sensor array 10 in columns. Hereinafter, the pixel 1000 may be referred to as a pixel circuit 1000.

The row control circuit 20 controls a plurality of pixels 1000 in rows, and the column control circuit 30 can read the detected flight time among the plurality of pixels 1000 included in one row and output the detected flight time to the outside.

When the LiDAR sensor 1 starts a sensing operation, a pulse-type light activation signal (LON) is provided to the light source 2 to irradiate laser with a predetermined period, such as 10 μs.

At this time, the period of irradiating the laser should be set sufficiently long in consideration of the detection range of the LiDAR sensor 1. For example, since the laser travels about 3,000 meters for 10 μs, it can be considered sufficient considering the detection range of a typical LiDAR sensor.

When laser is irradiated from a light source 2, a pixel 1000 selected from a pixel array 10 detects the reflected light reflected from an object 3.

In this embodiment, the time of flight (ToF) corresponds to time between when the laser is irradiated and when the reflected light is detected at the pixel 1000.

At this time, the pixel 1000 can detect not only the reflected light due to the laser irradiation but also ambient light.

If there is no noise due to ambient light, the flight time can be determined by detecting the reflected light from one laser irradiation, but in general environment, noise due to ambient light cannot be ignored, so the laser irradiations are performed multiple times and a histogram is generated to determine the flight time.

In order to detect a peak corresponding to the flight time from the histogram, it must be compared with the threshold. In the present disclosure, a threshold determination mode is first performed to determine the threshold by counting a light detection signal caused by ambient light in a predetermined time that is not affected by laser.

At this time, instead of performing a complex arithmetic calculation, a simple logic operation is performed on a count value obtained in the threshold determination mode to determine the threshold, which can reduce complexity of a circuit.

In the present embodiment, the flight time is determined by performing a coarse mode operation and a fine mode operation after the threshold determination mode is performed, and the number of laser irradiations required to determine the flight time is not fixed regardless of a pixel, but can vary for each pixel. That is, in the present embodiment, the exposure time required to determine the flight time can vary for each pixel.

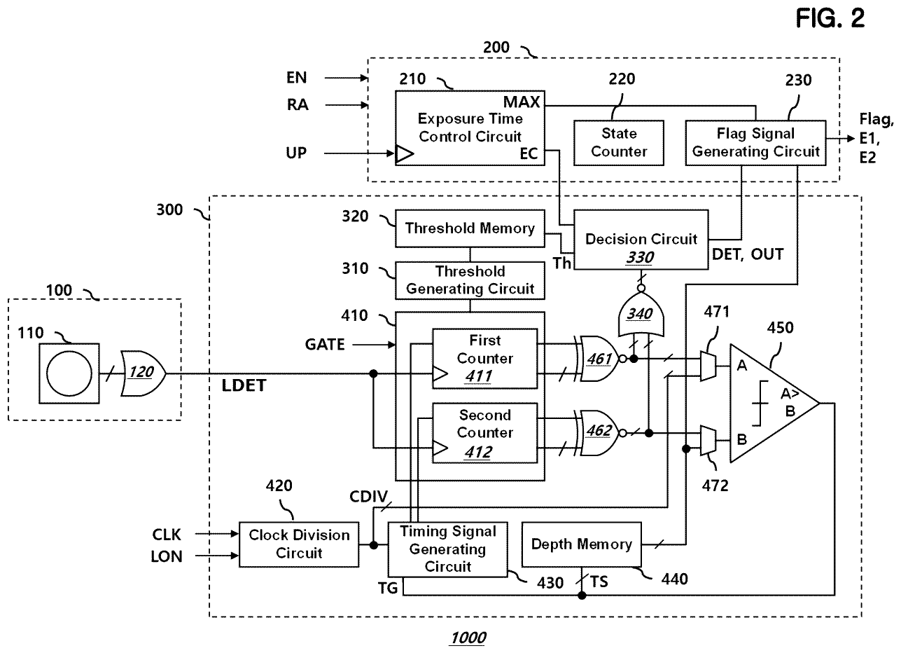

FIG. 2 is a block diagram showing the pixel 1000 according to an embodiment of the present disclosure.

The pixel 1000 includes a light detection circuit 100, a pixel control circuit 200, and a flight time detection circuit 300.

In FIG. 2, an enable signal EN, a row access signal RA, an exposure time increase signal UP, and a stop signal GATE may be provided from outside the sensor array 10, and in this embodiment, it is assumed that they are provided from the row control circuit 20.

The meaning of each signal will be described in detail below.

The light detection circuit 100 includes a plurality of light detection elements 110, each of which may be a single photon avalanche diode (SPAD), and a logic circuit 120 that generates a light detection signal LDET by performing an OR operation on signals output from the plurality of light detection elements 110.

The pixel control circuit 200 controls overall operations of the pixel 1000, variably adjusts exposure time for the pixel 1000, and enables a threshold used to determine a peak from a histogram to be determined in a simple manner.

In this embodiment, the pixel control circuit 200 can be implemented with a finite state machine (FSM).

At this time, the operation modes of the pixel 1000 include a threshold determination mode, a coarse mode, and a fine mode.

The coarse mode can be referred to as a first mode, and the fine mode can be referred to as a second mode.

In the first mode or in the coarse mode, the time of flight or the flight time is measured in a coarse time resolution, and in the second mode or in the fine mode, the flight time is measured in a fine time resolution. The fine time resolution is narrower than the coarse time resolution.

The threshold determination mode, the coarse mode, and the fine mode are sequentially performed to determine the flight time.

A time interval in which the flight time is determined once in the pixel 1000 can be referred to as a frame. When an operation is performed for the next frame after an operation for the current frame is completed, the above three operation modes may be performed repeatedly.

Since each frame corresponds to an exposure time, frame rate also changes according to change in the exposure time.

The coarse mode can be performed multiple times, and the number of times can vary depending on embodiments. When the coarse mode is performed multiple times, corresponding time resolution may be gradually narrowed down as the coarse mode is repeated.

The specific operation of the pixel control circuit 200 will be described in detail below.

The flight time detection circuit 300 counts the light detection signal LDET generated at the light detection circuit 100 according to reflected light and ambient light to generate a histogram and measures the flight time accordingly.

The flight time detection circuit 300 includes a counter circuit 410, a clock division circuit 420, a timing signal generating circuit 430, a depth memory 440, and a comparator 450.

The counter circuit 410 includes a first counter 411 and a second counter 412 that are triggered according to the light detection signal LDET.

The first counter 411 and the second counter 412 perform an up-count operation or a down-count operation according to a corresponding time slot.

In this embodiment, a plurality of time slots that are sequentially set with the same time interval are used.

In this embodiment, the plurality of time slots include a first time slot, a second time slot, a third time slot, and a fourth time slot, and these are identified by a time slot signal TS and the time slots may be represented as “00”, “01”, “10”, and “11”, respectively.

The first counter 411 operates in the first time slot and the third time slot, and performs an up-count operation in the first time slot and a down-count operation in the third time slot. The second counter 412 operates in the second time slot and the fourth time slot, and performs an up-count operation in the second time slot and a down-count operation in the fourth time slot.

After performing the count operations for a certain period of time, it is possible to determine a time slot where the peak of the histogram occurred by comparing the signs and absolute values of the first counter 411 and the second counter 412.

Each of the first counter 411 and the second counter 412 expresses positive and negative numbers in a 2's complement manner.

The flight time detection circuit 300 further includes a first XNOR gate 461 and a second XNOR gate 462.

The first XNOR gate 461 performs a bitwise XNOR operation on the most significant bit of the first counter 411 and the remaining bits thereof to generate a multi-bit signal representing a first absolute value, and the second XNOR gate 462 performs a bitwise XNOR operation on the most significant bit of the second counter 412 and the remaining bits thereof to generate a multi-bit signal representing a second absolute value.

The flight time detection circuit 300 further includes a first selection circuit 471 and a second selection circuit 472.

The first selection circuit 471 provides the first absolute value or an output of the clock division circuit 420 to the comparator 450 as a first input A thereof, and the second selection circuit 472 provides the second absolute value or an output of the depth memory 440 to the comparator 450 as a second input B thereof.

The comparator 450 can generate the time slot signal TS using a result of comparing the first absolute value and the second absolute value and a resulting sign bit, and the time slot signal TS is sequentially stored in the depth memory 440.

For example, if the time slot signal TS is determined as “10” when the coarse mode is performed for the first time, “1000” is stored in the depth memory 440, and if the time slot signal TS is determined as “01” when the coarse mode is performed for the second time, “1001” is stored in the depth memory 440.

The clock division circuit 420 can sequentially divide the clock signal CLK to generate multiple divided clock signals and can generate a multi-bit clock division signal CDIV corresponding to the multiple divided clock signals.

For example, if 7 divided clock signals are generated, a 7-bit clock division signal CDIV whose value corresponds to an up-count of the clock signal CLK may be generated in synchronization with the rising or falling edge thereof.

At this time, the clock division signal CDIV includes serial number information of the time slot.

In this embodiment, the clock division circuit 420 initializes the output thereof every time laser is irradiated by referring to the light activation signal LON.

Accordingly, even if the laser is irradiated multiple times, the consistency of the time slot can be maintained so that the histogram can be generated normally.

When the first selection circuit 471 outputs the upper 4 bits of the clock division signal CDIV and the second selection circuit 472 outputs the 4 bits of the depth memory 440, respectively and when they are equal to each other, the comparator 450 can activate a trigger signal TG and provide the trigger signal TG to the timing signal generating circuit 430.

When the trigger signal TG is activated, the timing signal generating circuit 430 uses the clock division signal CDIV generated by the clock division circuit 420 to sequentially determine the first time slot, the second time slot, the third time slot, and the fourth time slot each having a time interval corresponding to the current operation mode, and generates a signal for controlling the first counter 411 and the second counter 412 corresponding thereto.

In the present embodiment, the time interval of the time slot used in the coarse mode is reduced at a constant rate as the coarse mode is repeated.

For example, when performing the fine mode after performing the coarse mode twice and assuming that the interval of the time slot is 16 ms when a first coarse mode is performed, the interval of the time slot is set to 4 ms when a second coarse mode is performed.

In this embodiment, the time interval of the time slot used in the fine mode is shorter than the time interval of the time slot when the last coarse mode is performed.

For example, assuming that the interval of the time slot of the last coarse mode is 4 ms, the interval of the time slot of the fine mode is set to 2 ms.

By performing this process, the flight time can be determined with a precise resolution as a result of performing the coarse mode and the fine mode.

The operation of determining the flight time using the counter circuit 410, the clock division circuit 420, the timing signal generating circuit 430, the depth memory 440, and the comparator 450 is disclosed in the Korean Patent Publication Number KR 10-2023-0036978, and in an article S. Park, B. Kim, J. Cho, J.-H. Chun, J. Choi and S.-J. Kim, “An 80×60 Flash LiDAR Sensor with In-Pixel Histogramming TDC Based on Quaternary Search and Time-Gated Δ-Intensity Phase Detection for 45 m Detectable Range and Background Light Cancellation,” 2022 IEEE International Solid-State Circuits Conference (ISSCC), San Francisco, CA, USA, 2022, pp. 98-100, doi: 10.1109/ISSCC42614.2022.9731112., so detailed disclosure thereof will not be repeated.

The flight time detection circuit 300 determines a threshold that serves as a criterion for peak detection by performing a threshold determination mode, unlike the conventional one.

In the present embodiment, the threshold can be determined through a simple logic operation instead of using a complex arithmetic operation.

To this end, the flight time detection circuit 300 of this embodiment further includes a threshold generating circuit 310, a threshold memory 320, and a decision circuit 330.

The threshold generating circuit 310 generates a threshold from a count value generated by a counter circuit 410 when the threshold determination mode is performed, and the threshold memory 320 stores a threshold generated by the threshold generating circuit 310.

When the LiDAR sensor 1 starts operating, a pulse of a light activation signal LON is generated, and a laser is irradiated at a constant cycle.

The threshold determination mode is performed by selecting a section when the influence of the laser that has already been irradiated is small.

For example, if the laser is irradiated when the light activation signal LON is at a high level, and the light activation signal LON has the high level width of 1.0 μs and has a period of 10 μs, the threshold determination mode can be performed in a section between 3 μs and 8 μs after the light activation signal LON is activated.

If the threshold determination mode is performed for a certain period of time exceeding the cycle of the light activation signal LON, such as 20 μs, multiple laser irradiations can occur during the threshold determination mode.

Accordingly, the counting operation must be stopped in the remaining sections except for the section where the threshold determination mode is performed.

A stop signal GATE is provided to stop the threshold determination mode, and the counter circuit 410 can stop the counting operation accordingly.

Hereinafter, the time during which the threshold determination mode is performed is referred to as a reference time. Whether the reference time has elapsed can be managed by the row control circuit 20 together with the stop signal GATE.

In the conventional art, a threshold was calculated to distinguish a value due to background light from a peak value in a histogram generated after irradiating the laser multiple times.

The number of light detection signals LDET counted in one pixel 1000 during the reference time has a Poisson distribution.

If the number of detections due to ambient light per each laser irradiation is ω, the average number of detections when the laser is irradiated N times is λ, and the statistical confidence interval is c, the threshold Th can be calculated as the following Equation 1.

$$Th = λ + c \sqrt{λ} , λ = N \times ω \qquad [ Equation 1 ]$$

In the Equation 1, c\sqrt{λ}can be referred to as a deviation.

Through this, if the histogram has a value that is greater than a certain deviation from the average number of detections due to ambient light, it is considered as a peak.

In this way, in the conventional process of calculating the threshold, complex calculations such as addition, multiplication, and square root calculation were required.

In the present embodiment, the threshold is determined by performing a simple logic operation on the count value output from the counter circuit 410 after performing the threshold determination mode without performing complex calculations.

As aforementioned, in the coarse mode and in the fine mode, each of the first counter 411 and the second counter 412 operates as, for example, a 10-bit up/down counter.

In the threshold determination mode, in order to sufficiently secure noise information due to ambient light, the first counter 411 and the second counter 412 can be integrated and used as a single up counter. In this case, the counter circuit 410 can operate as, for example, a 20-bit up counter.

When the threshold determination mode starts, the counter circuit 410 is initialized and starts counting the light detection signal LDET output from the light detection circuit 100, and outputs a noise count value by counting the light detection signal LDET for the predetermined reference time.

In the present disclosure, the threshold is determined from the noise count value by considering the Poisson distribution.

If the noise count value is x and n is an integer equal to or greater than 0, the threshold Th according to the present disclosure is determined according to the Equation 2.

$$T h = c f ( x ) , \qquad [ Equation 2 ]$$

$$f ( x ) = {2}^{n} , where {2}^{2 n} \leq x < {2}^{2 ( n + 1 )}$$

In the Equation 2, c is a value corresponding to the confidence interval in the Poisson distribution, and c is 4 in this embodiment.

If the count value obtained in the threshold determination mode is an 8-bit value, the maximum value of n is 3, so the threshold can be determined immediately by examining bits corresponding to bit numbers 0, 2, 4, and 6 of the count value x. This is organized as shown in Table 1 below.

TABLE 1

| Bit #6 | Bit #4 | Bit #2 | Bit #0 | f(x) | Th |
|---|---|---|---|---|---|
| 1 | Don't care | Don't care | Don't care | 0000 1000 | 0010 0000 |
| 0 | 1 | Don't care | Don't care | 0000 0100 | 0001 0000 |
| 0 | 0 | 1 | Don't care | 0000 0010 | 0000 1000 |
| 0 | 0 | 0 | 1 | 0000 0001 | 0000 0100 |

The threshold generating circuit 310 can generate a threshold by performing a logic operation on the count value generated in the threshold determination mode as shown in Table 1, and this can be performed very simply compared to the complex arithmetic operation of the conventional method.

Since generating a logic circuit corresponding to Table 1 is obvious to a person skilled in the art, a detailed description thereof will be omitted.

The threshold generated according to the present disclosure is compared with the threshold generated by the conventional technique as follows.

First, in the present embodiment, when the coarse mode and the fine mode are performed, the first counter 411 and the second counter 412 perform up/down counting operations in a time-division manner, respectively, so that the average of the count value x converges to 0.

Accordingly, the threshold of the Equation 2 in the coarse mode and the fine mode can be viewed as corresponding to the deviation component of the Equation 1.

When the count value x is 27, the threshold generated by conventional calculation method using the Equation 1 is approximately 15.59.

The count value x is 27 which corresponds to “0001 1011” in binary format, so f(x) is “0000 0100” and the threshold is “0001 0000”, which is 16, according to the Equation 2.

In this way, the threshold derived by the present embodiment has a value similar to the threshold calculated by the conventional manner.

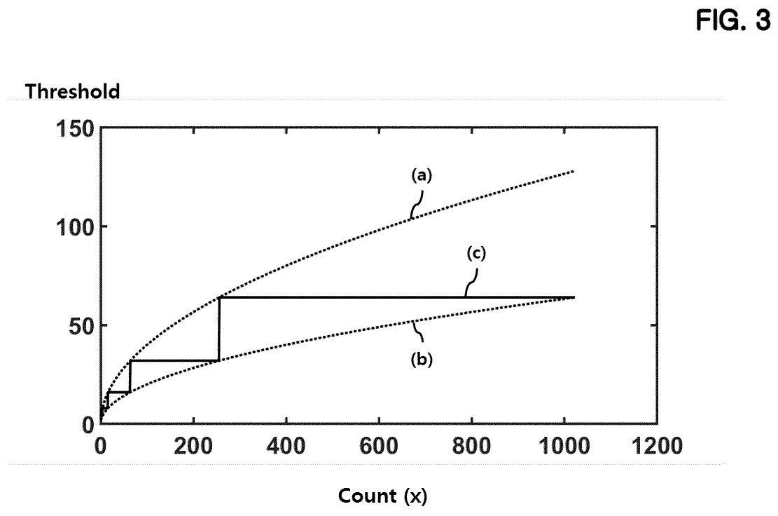

FIG. 3 is a graph comparing the threshold calculated by conventional technology and the threshold determined by the present embodiment.

In the graph, the horizontal axis corresponds to the count value and the vertical axis represents the threshold.

(a) corresponds to the case where c=4 in the Equation 1, (b) corresponds to the case where c=2 in the Equation 1, and (c) represents the threshold according to the Equation 2.

In this way, the threshold determined by the present embodiment is located between the cases where c=2 and c=4 in the conventional Poisson distribution and has a corresponding reliability.

It is obvious that the value of c in the Equation 2 can be adjusted according to the reliability level.

The decision circuit 330 detects a peak by comparing the threshold with the absolute values of the first counter 411 and the second counter 412 in the coarse mode and the fine mode.

The flight time detection circuit 300 further includes a NOR gate 340. The NOR gate 340 generates multi-bit signal by performing a bitwise NOR operation on the first absolute value output from the first XNOR gate 461 and the second absolute value output from the second XNOR gate 462 and provides the multi-bit signal to the decision circuit 330.

The decision circuit 330 activates a peak detection signal DET when the first absolute value or the second absolute value is greater than or equal to the threshold Th.

The decision circuit 330 can activate the out-of-range signal OUT when the value of the threshold Th is greater than the maximum value that can be output from the first counter 411 and the second counter 412.

When the out-of-range signal OUT is activated, there is no need to perform the coarse mode and the fine mode, so the operation of the next frame can be performed immediately.

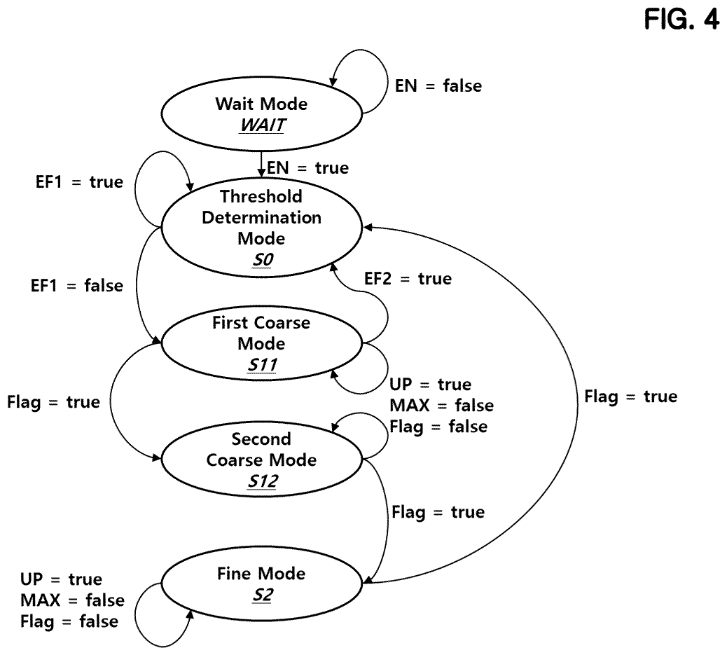

FIG. 4 is a state diagram showing operations of the LiDAR sensor according to one embodiment of the present disclosure.

In this embodiment, the states of the pixel 1000 include a wait mode WAIT, a threshold determination mode S0, a coarse mode S11 and S12, and a fine mode S2.

The pixel 1000 may be managed by a pixel control circuit 200 to transition from a wait mode WAIT to a threshold determination mode S0 in response to an enable signal EN provided from the row control circuit 20.

In the threshold determination mode 50, an operation is performed for the reference time as described above to determine the threshold Th.

The decision circuit 330 activates the out-of-range signal OUT when the threshold Th exceeds the maximum value that can be counted by the first counter 411 and the second counter 412, and the flag signal generating circuit 230 activates the first error flag EF1 with reference to the out-of-range signal OUT.

In the present embodiment, if the first error flag EF1 is activated, the threshold determination mode S is restarted.

If the first error flag EF1 is inactivated, it transitions to the next state.

In the present embodiment, the coarse mode is performed twice, and thus includes the first coarse mode S11 and the second coarse mode S12.

In other embodiments, the number of repetitions of the coarse mode can be adjusted differently.

The pixel control circuit 200 includes an exposure time control circuit 210, a state counter 220, and a flag signal generating circuit 230.

The flight time detection circuit 300 operates in units of reference time. As aforementioned, the reference time corresponds to the time when the threshold determination mode is performed.

If the exposure time becomes longer than the reference time, the threshold used in the flight time detection circuit 300 may be changed.

Whether the reference time has elapsed can be managed by the row control circuit 20 outside the pixel 1000, and if the reference time has elapsed, the row control circuit 20 can provide a rising pulse of the exposure time increase signal UP.

Accordingly, the exposure time control circuit 210 increases the exposure count EC. If the exposure count EC can no longer be increased, the exposure time control circuit 210 activates the maximum exposure signal MAX.

The state counter 220 manages the current state of the pixel 1000. The current state is one of the wait mode WAIT, the threshold determination mode S0, the first coarse mode S11, the second coarse mode S12, and the fine mode S2 as shown in FIG. 4.

The flag signal generating circuit 230 activates the flag signal Flag when the peak detection signal DET provided by the decision circuit 330 is activated.

When the flag signal Flag is activated, which means that a peak has been detected in the pixel 1000, the pixel 1000 immediately transitions to the next state.

For example, if the current state is the first coarse mode S11, it transitions to the second coarse mode S12, if the current state is the second coarse mode S12, it transitions to the fine mode S2, and if the current state is the fine mode S2, it transitions to the threshold determination mode S0.

When the current state is the first coarse mode S11, if the maximum exposure time is reached, that is the maximum exposure signal MAX is true, and if the peak detection signal DET of the decision circuit 330 is inactive, then the flag signal generating circuit 230 activates the second error flag EF2.

The second error flag EF2 indicates that the object 3 is out of the measurement range. After that, the pixel 1000 is initialized and the pixel 1000 transitions to the threshold determination mode S0.

After transitioning to the threshold determination mode S0, the threshold corresponding to the pixel 1000 is newly determined.

When the current state is the first coarse mode S11, if the exposure time is less than the maximum exposure time, that is the maximum exposure signal MAX is false, if the reference time has elapsed, if the exposure time increase signal UP is activated, and if the flag signal Flag is inactive, then the exposure time control circuit 210 controls the flight time detection circuit 300 to increase the exposure count EC and continue to perform the first coarse mode S11.

In this case, the decision circuit 330 must adjust the threshold value by referring to the exposure count EC of the exposure time control circuit 210.

In the Equation 2, the count value x is proportional to the reference time, therefore the threshold Th is proportional to the square root of the reference time.

For example, if the exposure count EC is m², the decision circuit 330 determines that the exposure time is m² times or more of the reference time, and adjusts the threshold to m times to perform a comparison operation, where m is a natural number greater than 1.

If the flag signal Flag is activated in the first coarse mode S11, it transitions to the second coarse mode S12.

Before starting the second coarse mode S12, the values of the first counter 411 and the second counter 412 and the exposure count EC are initialized.

In the second coarse mode S12, the time interval of the time slot is reduced to ¼ compared to that in the first coarse mode S11. Accordingly, the decision circuit 330 first adjusts the value of the threshold provided from the threshold memory 320 to ½ and then performs the operation.

In the second coarse mode S12, if the exposure time is less than the maximum exposure time and the flag signal Flag is inactive when the reference time has elapsed, the exposure count EC is increased and the second coarse mode S12 is additionally performed.

When the exposure count EC increases, adjusting the threshold Th is performed according to the same principle as described above. However, in the second coarse mode S12, the decision circuit 330 additionally adjusts the threshold according to the exposure count EC based on the half of the threshold stored in the threshold memory 320.

When the flag signal is activated in the second coarse mode S12, it transitions to the fine mode S2.

Before starting the fine mode S2, the values of the first counter 411 and the second counter 412 and the exposure count EC are initialized.

In the fine mode S2, since the time slot is sufficiently narrowed, it is considered that the noise due to the ambient light is sufficiently small. Accordingly, in the fine mode S2, a predetermined fixed value is used as a threshold regardless of the pixel 1000.

In the fine mode S2, when the reference time has elapsed, if the exposure time is less than the maximum exposure time and if the flag signal Flag is inactive, the exposure count EC is increased and the fine mode S2 is additionally performed.

However, the threshold is fixed to a predetermined value and does not change.

When the flag signal Flag is activated, it transitions to the threshold determination mode S0 and performs the operation for the next frame.

As aforementioned, the method of determining the flight time in the first and second coarse modes S11 and S12 and the fine mode S2 is the same as that disclosed in the Korean Patent Publication Number KR 10-2023-0036978A, and in an article S. Park, B. Kim, J. Cho, J.-H. Chun, J. Choi and S.-J. Kim, “An 80×60 Flash LiDAR Sensor with In-Pixel Histogramming TDC Based on Quaternary Search and Time-Gated Δ-Intensity Phase Detection for 45 m Detectable Range and Background Light Cancellation,” 2022 IEEE International Solid-State Circuits Conference (ISSCC), San Francisco, CA, USA, 2022, pp. 98-100, doi: 10.1109/ISSCC42614.2022.9731112., so a repeated disclosure thereof is omitted.

As aforementioned, the pixel 1000 can start an operation by the control of the row control circuit 20.

For example, the pixel 1000 can transition to the threshold determination mode S0 when the enable signal EN is activated by the row control circuit 20 while in the wait mode WAIT.

The pixel 1000 can transition to the threshold determination mode S0 after providing the finally generated flight time data to the column control circuit 30 according to the row access signal RA when the flag signal Flag is activated in the fine mode S2.

As aforementioned, in the present disclosure, the threshold can be determined by applying a simple logic operation to the count value measured in the threshold determination mode without performing complex arithmetic calculations.

In addition, in the present disclosure, if the pixel 1000 determines the flight time within one frame, the operation for the next frame is performed without waiting the operation of another pixel, so unnecessary waiting time is reduced.

Although various embodiments have been illustrated and described, various changes and modifications may be made to the described embodiments without departing from the spirit and scope of the disclosure as defined by the following claims.

What is claimed is:

1. A light detecting and ranging (LiDAR) sensor comprising:
a light detection circuit configured to generate a light detection signal by detecting light;
a flight time detection circuit configured to perform a threshold determination mode for determining a threshold during a reference time, and to perform a coarse mode for comparing an accumulated value of the light detection signal after light is irradiated from a light source with the threshold to determine a flight time corresponding to a distance to an object with a first resolution; and
a pixel control circuit configured to control the flight time detection circuit for performing the threshold determination mode and the coarse mode,
wherein the flight time detection circuit determines the threshold by performing a logical operation on a count value which is an accumulation of the light detection signal during the reference time when the light is not irradiated while the threshold determination mode is performed.

2. The LiDAR sensor of claim 1, wherein the flight time detection circuit further performs a fine mode to determine the flight time with a second resolution finer than the first resolution and the pixel control circuit controls the flight time detection circuit to perform the fine mode.

3. The LiDAR sensor of claim 2, wherein the flight time detection circuit compares an accumulation of the light detection signal with a predetermined threshold instead of the threshold determined at the threshold determination mode while the fine mode is performed.

4. The LiDAR sensor of claim 1, wherein the flight time detection circuit comprises:
a counter circuit configured to count the light detection signal;
a threshold generating circuit configured to perform a logical operation on a count value which is accumulated at the counter circuit during the reference time in the threshold determination mode;
a threshold memory storing the threshold; and
a decision circuit configured to determine a peak detection by comparing the threshold and an output of the counter circuit.

5. The LiDAR sensor of claim 4, wherein the counter circuit includes a first counter and a second counter,
wherein the first counter and the second counter are connected to each other and function as a single counter circuit during the threshold determination mode,
wherein the first counter and the second counter function as independent counters during the coarse mode, and
wherein the decision circuit determines the peak detection when an output of the first counter or an output of the second counter is greater than or equal to the threshold.

6. The LiDAR sensor of claim 5, wherein the decision circuit activates an out-of-range signal when the threshold is determined to be greater than a value that the first counter and the second counter can generate, and
wherein the pixel control circuit controls the flight time detection circuit to additionally perform the threshold determination mode when the out-of-range signal is activated.

7. The LiDAR sensor of claim 4, wherein when the count value is x, n is an integer greater than or equal to 0, and c is a natural number, the threshold determination circuit performs a logical operation on the count value to satisfy the equation
$$( Threshold ) = c \times {2}^{n} , where {2}^{2 n} \leq x < {2}^{2 ( n + 1 )} .$$

8. The LiDAR sensor of claim 7, wherein c is 4.

9. The LiDAR sensor of claim 4, wherein the decision circuit adjusts the threshold to compare with an accumulation of the light detection signal when an exposure time of the flight time detection circuit is greater than or equal to a predetermine number of times of the reference time.

10. The LiDAR sensor of claim 9, wherein the predetermined number is m² when m is a natural number greater than 1, and wherein the decision circuit increases the threshold by m times and compares an accumulation of the light detection signal therewith.

11. The LiDAR sensor of claim 9, wherein the pixel control circuit controls the flight time detection circuit so the threshold determination mode is additionally performed when the exposure time reaches maximum exposure time in the coarse mode while the decision circuit does not detect a peak.

12. The LiDAR sensor of claim 9, wherein the pixel control circuit includes:
an exposure time control circuit configured to manage the predetermined number as an exposure count;
a state counter configured to represent a state whether the flight time detection circuit performs the threshold determination mode or the coarse mode; and
a flag signal generating circuit configured to generate a flag according to whether the decision circuit detects a peak or not.
